(19) United States
(12) Patent Application Publication
(10) Pub. No.: US 2007/0019978 A1
(43) Pub. Date: Jan. 25, 2007

(54) Fixing unit for electrophotographic image forming apparatus

(75) Inventor: Jeonghwa Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/378,353

(22) Filed: Mar. 20, 2006

(30) Foreign Application Priority Data
Jul. 19, 2005 (KR) 10-2005-0065423

(51) Int. Cl. G03G 15/20

(52) U.S. Cl. 399/67; 399/328

(57) ABSTRACT

A fixing unit for an electrophotographic image forming apparatus is provided. The fixing unit includes a heating roller and a pressing roller provided opposite to form a fixing nip and apply pressure to a recording medium passing through the fixing nip. A heating roller holder rotatably supports heating roller shafts provided at both ends of the heating roller. A pressing roller holder is disposed a distance away from pressing roller shafts provided at both ends of the pressing roller, and includes an elastic member that elastically biases the pressing roller towards the heating roller between the pressing roller shafts and the pressing roller holder. A pressure controller controls a fixing pressure applied to the recording medium passing through the fixing nip by controlling a distance between the heating roller holder and the pressing roller holder.

### CROSS-REFERENCE TO RELATED PATENT APPLICATION

This application claims the benefit under 35 U.S.C. § 119(a) of Korean Patent Application No. 10-2005-0065423, filed on Jul. 19, 2005, in the Korean Intellectual Property Office, the entire disclosure of which is hereby incorporated by reference.

### BACKGROUND OF THE INVENTION

1. Field of the Invention

The present invention relates to a fixing unit for an electrophotographic image forming apparatus. More particularly, the present invention relates to a fixing unit that can efficiently perform color image fixation and high-speed printing by optimizing pressure between a heating roller and a pressing roller based on fixing environments.

2. Description of the Related Art

In common electrophotographic image forming apparatuses, light is illuminated onto a uniformly charged photosensitive medium to form an electrostatic latent image, the electrostatic latent image is developed by the use of a toner of a predetermined color, and the developed image is then transferred and fixed onto a recording medium to form an image. The electrophotographic image forming apparatus includes a fixing unit which fixes the toner image onto the recording medium by applying heat and pressure on the toner image transferred onto the recording medium.

FIG. 1 is a schematic view of a conventional fixing unit for an electrophotographic image forming apparatus.

Referring to FIG. 1, the conventional fixing unit includes a heating roller 11 and a pressing roller 13. The heating roller 11 includes a metal pipe 11a having a predetermined diameter, an elastic rubber layer 11b that covers the metal pipe 11a, and a release layer (not shown) formed on the surface of the elastic rubber layer 11b. In addition, a heat source (not shown) which heats the heating roller 11 to a predetermined temperature is provided in the heating roller 11. The pressing roller 13 is disposed such that a predetermined pressure is applied onto the heating roller 11 while rotating in contact with the heating roller 11. In addition, an elastic member 17 such as a spring is disposed to a bushing 22 that supports a pressing roller axis 21 which maintains the pressure applied from the pressing roller 13 onto the heating roller 11. The elastic member 17 elastically biases the pressing roller 13 towards the heating roller 11. The pressing roller 13 may be formed of a metal pipe, an elastic rubber layer, and a release layer. In the aforementioned configuration, a toner image 15 that has not been fixed onto a recording medium P is heated and pressurized when passing through a fixing nip formed between the heating roller 11 and the pressing roller 13, to fix the image onto the recording medium P.

In this conventional fixing unit, the pressure applied onto the recording medium P in the fixing nip is predetermined by the spring constant of the elastic member 17.

To cope with recent demands for high speed printing by an electrophotographic color image forming apparatus, a method of increasing the outer circumference of the heating roller and the pressing roller or a method of increasing the thickness of the elastic rubber layer has been developed. These methods attempt to guarantee that the recording medium stay in the fixing nip for a sufficient length of time by extending the width of the fixing nip formed between the heating roller and the pressing roller. This helps prevent a possible drop in the quality of image fixation when printing speed increases. The method of increasing the outer circumference of the heating roller and the pressing roller, however, is limited by the size of the image forming apparatus, and also has disadvantages in that warm-up time and production costs increase. In the method of increasing the thickness of the elastic rubber layer, the surface temperature of the thick elastic rubber layer must be maintained to a fixing temperature by further increasing the temperature of the metal pipe. This may cause problems such as a deterioration of the contact between the metal pipe and the elastic rubber layer or of the elastic rubber layer itself. Furthermore, durability may become worse.

Another method of increasing fixing capability for high speed printing is to increase the pressure in the fixing nip. Pressure is one of the most significant factors, along with temperature, for fixing a toner image. Temperature and pressure must be flexible to meet fixing conditions which vary according to the type of toner and the type and thickness of the recording medium. When temperature is raised, however, the elastic rubber layer may be deteriorated or durability may be worsened, as mentioned above. Meanwhile, extremely high pressure in the fixing nip may lead to a durability problem stemming from severe distortion in the elastic rubber layer, a paper jam may take place when paper movement deteriorates, and the apparatus may be under excessive load as the required driving torque increases. Thus, it may not be desirable to set the pressure in the fixing nip to the maximum value to secure fixing capability under all conditions.

Accordingly, there is a need for securing the fixing capability, which is required for color image fixation and high speed printing, by varying the pressure in the fixing nip according to the type of recording medium and the type of toner image, instead of setting it to a fixed value.

### SUMMARY OF THE INVENTION

An aspect of the present invention is to address at least the above problems and/or disadvantages and to provide at least the advantages described below. Accordingly, an aspect of the present invention is to provide a fixing unit that can efficiently perform color image fixation and high speed printing by optimizing the pressure between a heating roller and a pressing roller based on environmental conditions.

According to an aspect of the present invention, a fixing unit for an electrophotographic image forming apparatus comprises a heating roller having a heat source therein, and a pressing roller rotatably disposed opposite to the heating roller to form a fixing nip and apply pressure to a recording medium passing through the fixing nip. A heating roller holder rotatably supports the heating roller. A pressing roller holder is disposed a distance away from shafts of the pressing roller. An elastic member that elastically biases the pressing roller towards the heating roller is disposed between the pressing roller shafts and the pressing roller holder. A pressure controller controls a fixing pressure applied to the recording medium passing through the fixing nip by controlling a distance between the heating roller holder and the pressing roller holder.

The pressure controller may comprise a driving motor and a lead screw that controls the distance between the heating roller holder and the pressing roller holder while being rotated by the driving motor.

The heating roller holder may rotatably support the lead screw, and the pressing roller holder linearly reciprocates as the lead screw rotates.

The driving motor and the lead screw may be respectively provided at each side of the heating roller holder and the pressing roller holder.

A sensor which senses a type of the recording medium passing through the fixing nip and detects a state of a toner image, and a driving control unit which determines a fixing pressure based on a signal input from the sensor and controls the rotation of the driving motor to achieve the determined fixing pressure may be provided.

A bushing which rotatably supports the pressing roller shaft and in which one part of the elastic member is disposed may be disposed on the pressing roller shaft.

The pressure between the heating roller holder and the pressing roller may be released in a standby mode after print operation is complete.

According to another aspect of the present invention, a fixing unit for an electrophotographic image forming apparatus comprises a heating roller, a pressing roller rotatably disposed opposite to the heating roller to form a fixing nip between the heating roller and the pressing roller, a heating roller holder which rotatably supports the heating roller, a pressing roller holder which rotatably supports the pressing roller, and a pressure controller which controls a fixing pressure applied onto a recording medium passing through the fixing nip by controlling a distance between the heating roller holder and the pressing roller holder.

According to yet another aspect of the present invention, a fixing unit for an electrophotographic image forming apparatus comprises a heating roller, a pressing roller rotatably disposed opposite to the heating roller to form a fixing nip, a heating roller holder which rotatably supports the heating roller, a pressing roller holder which rotatably supports the pressing roller, and means for controlling a fixing pressure applied to a recording medium passing through the fixing nip by controlling a distance between the heating roller holder and the pressing roller holder.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional fixing unit for an electrophotographic image forming apparatus;

FIG. 2 is a schematic view of a fixing unit for an electrophotographic image forming apparatus according to an exemplary embodiment of the present invention;

FIGS. 3A through 3C are views illustrating an operational process of the fixing unit according to the exemplary embodiment of the present invention; and

FIG. 4 is a schematic view of the fixing unit for the electrophotographic image forming apparatus according to another exemplary embodiment of the present invention.

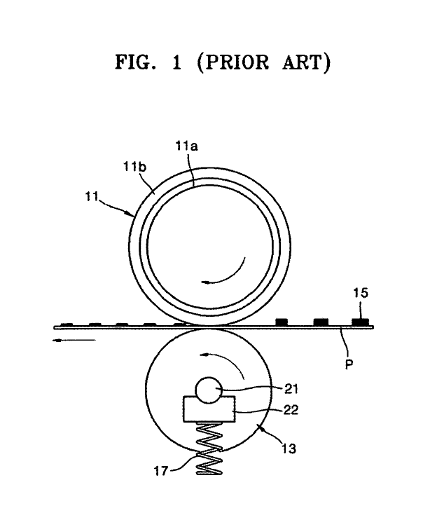

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

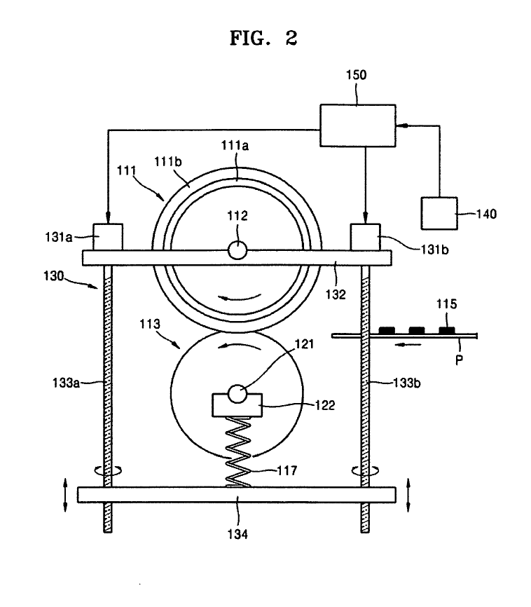

FIG. 2 is a schematic view of a fixing unit for an electrophotographic image forming apparatus according to an exemplary embodiment of the present invention.

Referring to FIG. 2, a heating roller 111 and a pressing roller 113 are disposed to face each other in a rotatable manner. A heat source (not shown) for heating the heating roller 111 to a predetermined temperature, such as a lamp, is provided in the heating roller 111. The heating roller 111 includes a metal pipe 111a having a predetermined diameter, an elastic rubber layer 111b laminated to a predetermined thickness on the outer surface of the metal pipe 111a, and a release layer (not shown) formed on the surface of the elastic rubber layer 111b. A heating roller shaft 112 is provided at each end of the heating roller 111, and each of the heating roller shafts 112 is rotatably supported by a heating roller holder 132.

The pressing roller 113, which applies pressure on the heating roller 111 while rotating in contact with the heating roller 111 during printing operation, is disposed under the heating roller 111. Thus, when a recording medium P on which a toner image 115 is formed passes through a fixing nip formed between the heating roller 111 and the pressing roller 113 during printing operation, the pressing roller 113 applies a predetermined fixing pressure towards the heating roller 111. The pressing roller 113 includes a metal pipe having a predetermined diameter, an elastic rubber layer laminated onto the outer surface of the metal pipe, and a release layer (not shown) formed on the surface of the elastic rubber layer. A pressing roller shaft 121 is provided at each end of the pressing roller 113, and each of the pressing roller shafts 121 is rotatably supported by a bushing 122.

A pressing roller holder 134 is disposed a predetermined distance away from the lower portion of the bushing 122. An elastic member 117 that elastically biases the pressing roller 113 towards the heating roller 111 is disposed between the bushing 122 and the pressing roller holder 134. By the use of the elastic member 117, the pressing roller 113 applies predetermined pressure on the heating roller 111 while rotating in contact with the heating roller 111 during printing operation. In the exemplary embodiment of the present invention, the elastic member 117 is a spring. However, other types of elastic members 117 that elastically bias the pressing roller 113 towards the heating roller 111 may be used.

A pressure controller 130 for controlling the pressure between the heating roller 111 and the pressing roller 113 is disposed at both sides of the heating roller 111 and the pressing roller 113. The pressure controller 130 is disposed at one side of the heating roller 111 and the pressing roller 113 shown in FIG. 2 and is also disposed at the other side of the heating roller 111 and the pressing roller 113.

The pressure controller 130 controls the fixing pressure applied on the recording medium P that passes through the fixing nip formed between the heating roller 111 and the pressing roller 113 by controlling the distance between the heating roller 132 and the pressing roller holder 134 during printing operation. The pressure controller 130 includes first and second driving motors 131a and 131b, and first and second lead screws 133a and 133b that respectively rotate in accordance with the first and second driving motors 131a and 131b. The upper part of the first lead screw 133a is connected to one side of the heating roller holder 132, and the lower part of the first lead screw 133a is connected to one side of the pressing roller holder 134. One side of the heating roller holder 132 rotatably supports the first lead screw 133a, and one side of the pressing roller holder 134 linearly reciprocates upwards and downwards as the first lead screw 133a rotates. The upper part of the second lead screw 133b is connected to the other side of the heating roller holder 132, and the lower part of the second lead screw 133b is connected to the other side of the pressing roller holder 134. In an exemplary embodiment, the other side of the heating roller holder 132 rotatably supports the second lead screw 133b, and the other side of the pressing roller holder 134 linearly reciprocates upwards and downwards as the second lead screw 133b rotates. When the first and second lead screws 133a and 133b are rotated by the first and second driving motors 131a and 131b in such a configuration, the heating roller holder 132 is fixed and the pressing roller holder 134 is moved upwards and downwards, thus the distance between the heating roller holder 132 and the pressing roller holder 134 changes. Accordingly, the pressure applied between the heating roller 111 and the pressing roller 113 can be controlled.

The fixing unit according to the exemplary embodiment of the present invention includes a sensor 140 and a driving control unit 150 that controls driving of the first and second driving motors 131a and 131b. The sensor 140 serves to sense the type or thickness of a recording medium P that passes through the fixing nip between the heating roller 111 and the pressing roller 113, or to sense the state of a toner image 115. In addition, the driving control unit 150 determines optimum fixing pressure based on a signal input from the sensor 140, and then controls the first and second driving motors 131a and 131b based on the determined fixing pressure.

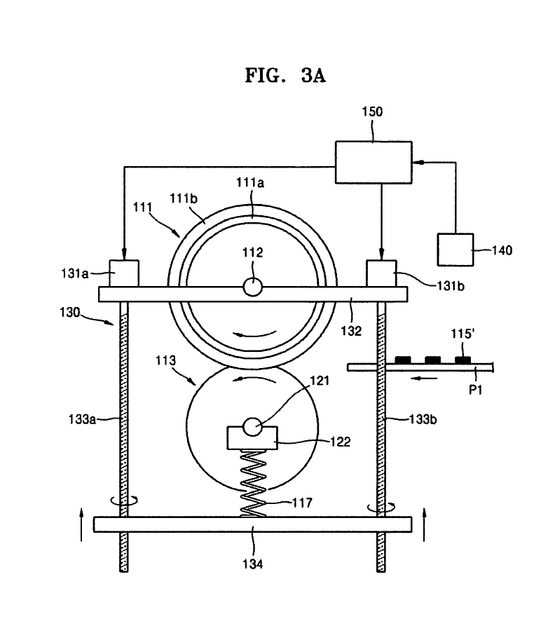

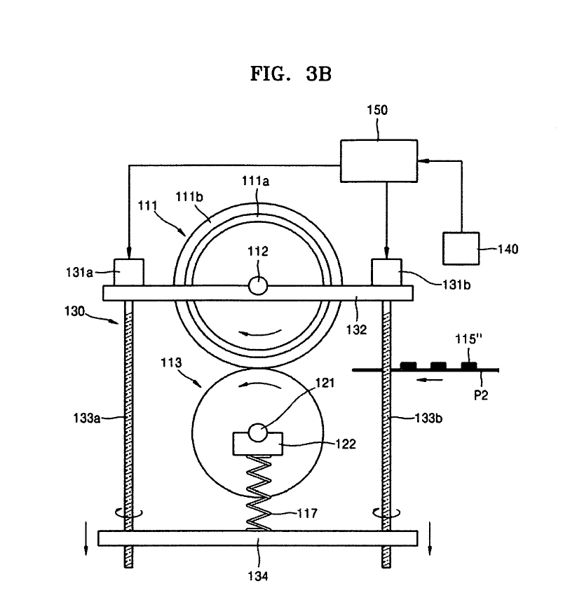

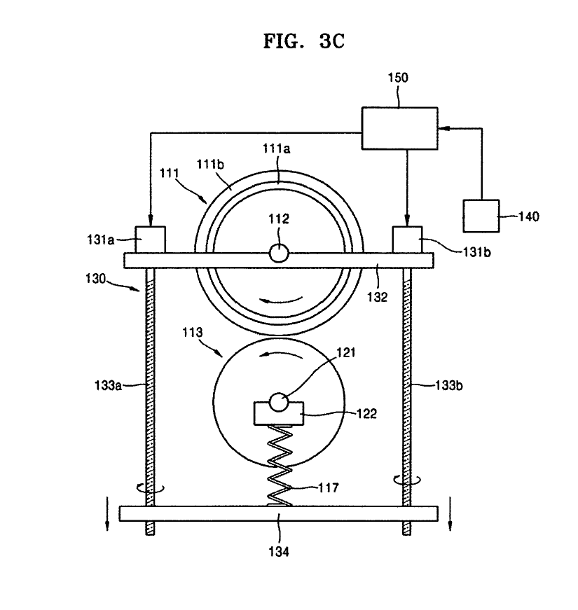

The operation of the fixing unit according to an exemplary embodiment of the invention will now be described with reference to FIGS. 3A through 3C.

FIG. 3A is a view illustrating an operational process of the fixing unit according to the exemplary embodiment of the present invention for securing high fixing pressure for a thick recording medium P1 or a color toner image 115′. Referring to FIG. 3A, the sensor 140 first detects the thick recording medium P1 or the color toner image 115′, and then sends the detected signal to the driving control unit 150. Next, the driving control unit 150 determines a desired fixing pressure based on a signal input from the sensor 140, and then drives the first and second driving motors 131a and 131b based on the determined fixing pressure so as to rotate the first and second lead screws 133a and 133b counterclockwise as shown in FIG. 3A for example. As a result, the pressing roller holder 134 is raised to increase the pressure between the heating roller 111 and the pressing roller 113. Here, the driving control unit 150 controls the first and second driving motors 131a and 131b, so that the pressing roller holder 134 is raised until the pressure between the heating roller 111 and the pressing roller 113 reaches the determined fixing pressure.

FIG. 3B is a view illustrating an operational process of the fixing unit according to the exemplary embodiment of the present invention for securing a lower fixing pressure that is required for a thin recording medium P2 or a monochrome toner image 115″. Referring to FIG. 3B, the sensor 140 first detects the thin recording medium P2 or the monochrome toner image 115″, and then sends the detected signal to the driving control unit 150. Next, the driving control unit 150 determines a desired fixing pressure based on a signal input from the sensor 140, and then drives the first and second driving motors 131a and 131b based on the determined fixing pressure so as to rotate the first and second lead screws 133a and 133b clockwise as shown in FIG. 3B for example. As a result, the pressing roller holder 134 is lowered to reduce the pressure between the heating roller 111 and the pressing roller 113. Here, the driving control unit 150 controls the first and second driving motors 131a and 131b, so that the pressing roller holder 134 is lowered until the pressure between the heating roller 111 and the pressing roller 113 reaches the determined fixing pressure.

FIG. 3C is a view of the fixing unit according to the exemplary embodiment of the present invention in a standby mode after a printing operation is complete. Referring to FIG. 3C, the driving control unit 150 drives the first and second driving motors 131a and 131b after the print operation is complete to further lower the pressing roller holder 134, so that the heating roller 111 is separated from the pressing roller 113. Accordingly, the pressure applied between the heating roller 111 and the pressing roller 113 is released.

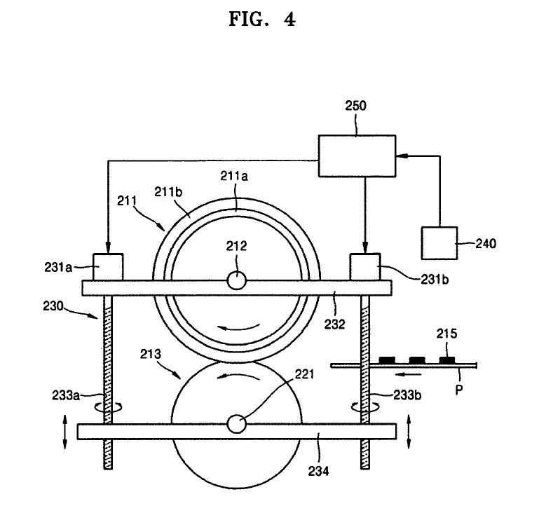

FIG. 4 is a schematic view of a fixing unit for the electrophotographic image forming apparatus according to another exemplary embodiment of the present invention.

Referring to FIG. 4, a heating roller 211 and a pressing roller 213 are disposed to face each other in a rotatable manner, and a heat source (not shown) is provided in the heating roller 211. The heating roller 211 includes a metal pipe 211a having a predetermined diameter, an elastic rubber layer 211b laminated to a predetermined thickness on the outer surface of the metal pipe 211a, and a release layer (not shown) formed on the surface of the elastic rubber layer 211b. A heating roller shaft 212 is provided at each end of the heating roller 211, and each of the heating roller shafts 212 is rotatably supported by a heating roller holder 232.

The pressing roller 213, which applies pressure on the heating roller 211 while rotating in contact with the heating roller 211 during a printing operation, is disposed under the heating roller 211. The pressing roller 213 includes a metal pipe having a predetermined diameter, an elastic rubber layer laminated onto the outer surface of the metal pipe, and a release layer (not shown) formed on the surface of the elastic rubber layer. A pressing roller shaft 221 is provided at each end of the pressing roller 213, and each of the pressing roller shafts 221 is rotatably supported by a pressing roller holder 234.

A pressure controller 230 for controlling the pressure between the heating roller 211 and the pressing roller 213 is disposed at each side of the heating roller 211 and the pressing roller 213. The pressure controller 230 is disposed at one side of the heating roller 211 and the pressing roller 213 shown in FIG. 4 is disposed at the other side of the heating roller 211 and the pressing roller 213.

The pressure controller 230 controls the fixing pressure applied on a recording medium P that passes through the fixing nip formed between the heating roller 211 and the pressing roller 213 by controlling the distance between the heating roller 232 and the pressing roller holder 234 during printing operation. The pressure controller 230 includes first and second driving motors 231a and 231b, and first and second lead screws 233a and 233b that respectively rotate in accordance with the first and second driving motors 231a and 231b. The upper part of the first lead screw 233a is connected to one side of the heating roller holder 232, and the lower part of the first lead screw 233a is connected to one side of the pressing roller holder 234. One side of the heating roller holder 232 rotatably supports the first lead screw 233a, and one side of the pressing roller holder 234 linearly reciprocates upwards and downwards as the first lead screw 233a rotates. The upper part of the second lead screw 233b is connected to the other side of the heating roller holder 232, and the lower part of the second lead screw 233b is connected to the other side of the pressing roller holder 234. The other side of the heating roller holder 232 rotatably supports the second lead screw 233b, and the other side of the pressing roller holder 234 linearly reciprocates upwards and downwards as the second lead screw 233b rotates. When the first and second lead screws 233a and 233b are rotated by the first and second driving motors 231a and 231b in such a configuration, the heating roller holder 232 is fixed and the pressing roller holder 234 is moved upwards and downwards, thus the distance between the heating roller holder 232 and the pressing roller holder 234 changes. Accordingly, the pressure between the heating roller 211 and the pressing roller 213 can be controlled.

The fixing unit according to another exemplary embodiment of the present invention includes a sensor 240 and a driving control unit 250 that controls the first and second driving motors 231a and 231b. The sensor 240 senses the type or thickness of the recording medium P that passes through the fixing nip between the heating roller 211 and the pressing roller 213, or senses a state of a toner image 215. In addition, the driving control unit 250 determines the optimum fixing pressure based on a signal input from the sensor 240, and then controls the first and second driving motors 231a and 231b based on the determined fixing pressure. The operation of the fixing unit according to this exemplary embodiment of the present invention is similar to the operation of the previous exemplary embodiment, so a detailed description will not be repeated.

A fixing unit for an electrophotographic image forming apparatus according to the exemplary embodiments of the present invention may achieve the following advantages.

First, fixing pressure can be varied during a printing operation based on fixing environments, such as the type or thickness of a recording medium, or the type of toner image, so that a desired fixing condition can be met. Thus, fixing capability required for color image fixation or high speed printing can be achieved.

Second, pressure between the heating roller and the pressing roller is released after a printing operation is complete, which prevents the central part of the pressing roller from sagging. In addition, the lifespan of the elastic rubber layer included in the heating roller and the pressing roller is improved.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fixing unit for an electrophotographic image forming apparatus, comprising:
a heating roller;
a pressing roller rotatably disposed opposite to the heating roller to form a fixing nip between the heating roller and the pressing roller;
a heating roller holder which rotatably supports the heating roller;
a pressing roller holder which is disposed a distance away from the pressing roller, the pressing roller holder comprising an elastic member disposed between the pressing roller and the pressing roller holder for elastically biasing the pressing roller towards the heating roller; and
a pressure controller which controls a fixing pressure applied onto a recording medium passing through the fixing nip by controlling a distance between the heating roller holder and the pressing roller holder.

2. The fixing unit according to claim 1, wherein the pressure controller comprises:
a driving motor; and
a lead screw that controls the distance between the heating roller holder and the pressing roller holder while being rotated by the driving motor.

3. The fixing unit according to claim 2, wherein the heating roller holder rotatably supports the lead screw, and the pressing roller holder linearly reciprocates as the lead screw rotates.

4. The fixing unit according to claim 2, wherein the driving motor and the lead screw are respectively provided at both sides of the heating roller holder and the pressing roller holder.

5. The fixing unit according to claim 2, further comprising:
a sensor which senses a type of the recording medium passing through the fixing nip and a state of a toner image; and
a driving control unit for determining a fixing pressure based on a signal from the sensor and controlling the rotation of the driving motor to create the determined fixing pressure.

6. The fixing unit according to claim 1, further comprising at least one bushing which rotatably supports a shaft of the pressing roller, one end of the elastic member being disposed on the at least one bushing.

7. The fixing unit according to claim 1, wherein the pressure between the heating roller and the pressing roller is released in a standby mode after a print operation is complete.

8. A fixing unit for an electrophotographic image forming apparatus, the fixing unit comprising:
a heating roller;
a pressing roller rotatably disposed opposite to the heating roller to form a fixing nip between the heating roller and the pressing roller;
a heating roller holder which rotatably supports the heating roller;
a pressing roller holder which rotatably supports the pressing roller; and
a pressure controller which controls a fixing pressure applied onto a recording medium passing through the fixing nip by controlling a distance between the heating roller holder and the pressing roller holder.

9. The fixing unit according to claim 8, wherein the pressure controller comprises:
a driving motor; and
a lead screw that controls the distance between the heating roller holder and the pressing roller holder while being rotated by the driving motor.

10. The fixing unit according to claim 9, wherein the heating roller holder rotatably supports the lead screw, and the pressing roller holder linearly reciprocates as the lead screw rotates.

11. The fixing unit according to claim 9, wherein the driving motor and the lead screw are respectively provided at both sides of the heating roller holder and the pressing roller holder.

12. The fixing unit according to claim 9, further comprising:
a sensor which senses a type of the recording medium passing through the fixing nip and a state of a toner image; and
a driving control unit for determining a fixing pressure based on a signal from the sensor and controlling the rotation of the driving motor to create the determined fixing pressure.

13. The fixing unit according to claim 8, wherein the pressure between the heating roller and the pressing roller is released in a standby mode after a print operation is complete.

14. A fixing unit for an electrophotographic image forming apparatus, the fixing unit comprising:
a heating roller;
a pressing roller rotatably disposed opposite to the heating roller to form a fixing nip;
a heating roller holder which rotatably supports the heating roller;
a pressing roller holder which rotatably supports the pressing roller; and
means for controlling a fixing pressure applied to a recording medium passing through the fixing nip by controlling a distance between the heating roller holder and the pressing roller holder.

15. The fixing unit according to claim 14, further comprising an elastic member disposed between the pressing roller and the pressing roller holder for elastically biasing the pressing roller towards the heating roller.

16. The fixing unit according to claim 14, wherein the means for controlling a fixing pressure comprises:
a lead screw connecting the heating roller holder and the pressure roller holder; and
a driving motor for rotating the lead screw to vary the distance between the heating roller holder and the pressing roller holder.

17. The fixing unit according to claim 16, wherein the driving motor and the lead screw are respectively provided at both sides of the heating roller holder and the pressing roller holder.

18. The fixing unit according to claim 14, wherein the heating roller holder rotatably supports the lead screw, and the pressing roller holder linearly reciprocates as the lead screw rotates.

19. The fixing unit according to claim 14, further comprising:
a sensor for sensing a type of a recording medium passing through the fixing nip and a state of a toner image; and
a driving control unit for determining a fixing pressure based on a signal from the sensor and controlling the driving motor to create the determined fixing pressure.

20. The fixing unit according to claim 14, wherein the pressure between the heating roller and the pressing roller is released in a standby mode after a print operation is complete.
